(19) United States
(12) Patent Application Publication
(10) Pub. No.: US 2008/0040452 A1
(43) Pub. Date: Feb. 14, 2008

(54) Device and network capable of mobile diagnostics based on diagnostic management objects

(76) Inventors: Bindu Rama Rao, Laguna Niguel, CA (US); Robert C. Daley, Nashua, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/728,517

(22) Filed: Mar. 26, 2007

Related U.S. Application Data
(60) Provisional application No. 60/785,879, filed on Mar. 24, 2006.

(51) Int. Cl. G06F 15/16

(52) U.S. Cl. 709/219

(57) ABSTRACT

A device management (DM) technique in which diagnostics management objects (diagnostics MOs) are created and used for remotely detecting and resolving problems with specific device features or applications in an electronic device in a network. The network is capable of supporting customer care calls from a user of the electronic device that might be having difficulties and desire help diagnosing a problem. By employing diagnostics MOs in the electronic device, the network is able to remotely determine an appropriate solution based on the diagnostics information returned by the electronic device.

The present application makes reference to, claims priority to, and claims benefit of U.S. Provisional Patent Application Ser. No. 60/785,879, filed Mar. 24, 2006, the complete subject matter of which is hereby incorporated herein by reference, in its entirety.

The present application also makes reference to U.S. Provisional Patent Application Ser. No. 60/664,249 titled “DEVICE CLIENT SPECIFICATION”, filed Mar. 21, 2005, and U.S. patent application Ser. No. 11/385,162 titled “DEVICE CLIENT SPECIFICATION”, filed Mar. 21, 2006, the complete subject matter of each of which is hereby incorporated herein by reference, in its entirety.

### BACKGROUND OF THE INVENTION

Electronic devices such as mobile phones, personal digital assistants (PDA's), pagers, and handheld personal computers, for example, often contain firmware and application software that are either provided by the manufacturers of the electronic devices, by telecommunication carriers, or by third parties. If software or firmware components are to be changed in such electronic devices, it is typically very risky to update these code components. It is even more difficult to remotely determine what is wrong with such devices, so that appropriate firmware updates can be identified and installed.

It is often difficult to determine what is wrong with such electronic devices when a problem is encountered. Quite often, a customer care representative of a carrier network does not have answers to a customer's problem and is not able to fix it. Determination of problems with a customer's mobile electronic device is a major issue for network operators, because answering customer care calls is quite expensive. This is especially true if at the end of such a call, the customer care representative has been unable to determine what is wrong with the electronic device and resolve the customer complaint.

Different electronic devices have different sets of resources, different sets of parameters, etc. needed for operation, and managing mobile electronic devices in a heterogeneous network is a challenge. Determining which parameters need to be set or changed in an electronic device to correct a problem can be a major undertaking.

Recently, organizations such as the Open Mobile Alliance (OMA) have announced a desire to address diagnostics for mobile devices, and have decided to gather requirements. These requirements, however, are at a very high level, and technical specifications or solutions of any sort are not anticipated to be available for some time.

Because a device can undergo firmware and/or software updates and acquire new capabilities, a solution is needed that addresses the determination of new device capabilities and the detection of problems in the operation and configuration of such devices, and that provides mechanisms to determine and resolve the problems that occur.

Device features such as, for example, OMA enablers that are supported by an electronic device can develop operational problems and may need diagnosis.

Further limitations and disadvantages of conventional and traditional approaches will become apparent to one of skill in the art, through comparison of such systems with the representative embodiments of the present invention as set forth in the remainder of the present application with reference to the drawings.

### BRIEF DESCRIPTION OF SEVERAL VIEWS OF THE DRAWINGS

FIG. 1 is a perspective block diagram of an exemplary network that supports remote diagnosis of an electronic device such as, for example, a mobile handset or personal digital assistant, in accordance with a representative embodiment of the present invention.

FIG. 2 shows elements of an exemplary simple diagnostic function management object (MO) (DiagnosticFunctionMO), in accordance with a representative embodiment of the present invention.

FIG. 3 shows elements of an exemplary diagnostic function MO (DiagnosticFunctionMO) with name-value pair parameters, in accordance with a representative embodiment of the present invention.

FIG. 4 illustrates the elements of an exemplary custom diagnostic function MO (CustomDiagnosticFunctionMO), in accordance with a representative embodiment of the present invention.

FIG. 5 illustrates the elements of an exemplary trap MO (TrapMO), in accordance with a representative embodiment of the present invention.

FIG. 6 illustrates the elements of another exemplary trap management object (TrapMO), in accordance with a representative embodiment of the present invention.

FIG. 7 illustrates the elements of an exemplary trap with schedule management object (TrapWithSchedMO) with a schedule for collecting and reporting, in accordance with a representative embodiment of the present invention.

FIG. 8 illustrates the elements of an exemplary custom trap set management object (CustomTrapSetMO) with a schedule for collecting and reporting, in accordance with a representative embodiment of the present invention.

FIG. 9 illustrates the elements of an exemplary scheduling management object with trap (ScheduleMOWithTrap), in accordance with a representative embodiment of the present invention.

FIG. 10 illustrates elements of an exemplary device profile management object DeviceProfile MO, in accordance with a representative embodiment of the present invention.

FIG. 11 illustrates the elements of an exemplary custom device profile management object CustomDeviceProfile MO, in accordance with representative embodiment of the present invention.

### DETAILED DESCRIPTION OF THE INVENTION

Aspects of the present invention relate generally to the remote management of electronic devices and, more specifically, to the use of device management objects for mobile diagnostics. A representative embodiment of the present invention permits the operator of a network of mobile electronic devices to, among other things, monitor for events of interest in an electronic device, flag events as they occur, collect data about the event(s), and communicate collected data to a remote server. A representative embodiment of the present invention may employ a number of different methods of data collection including, for example, a cumulative counter (CC) method, a gauge, discrete event registration (DER), and status inspection (SI).

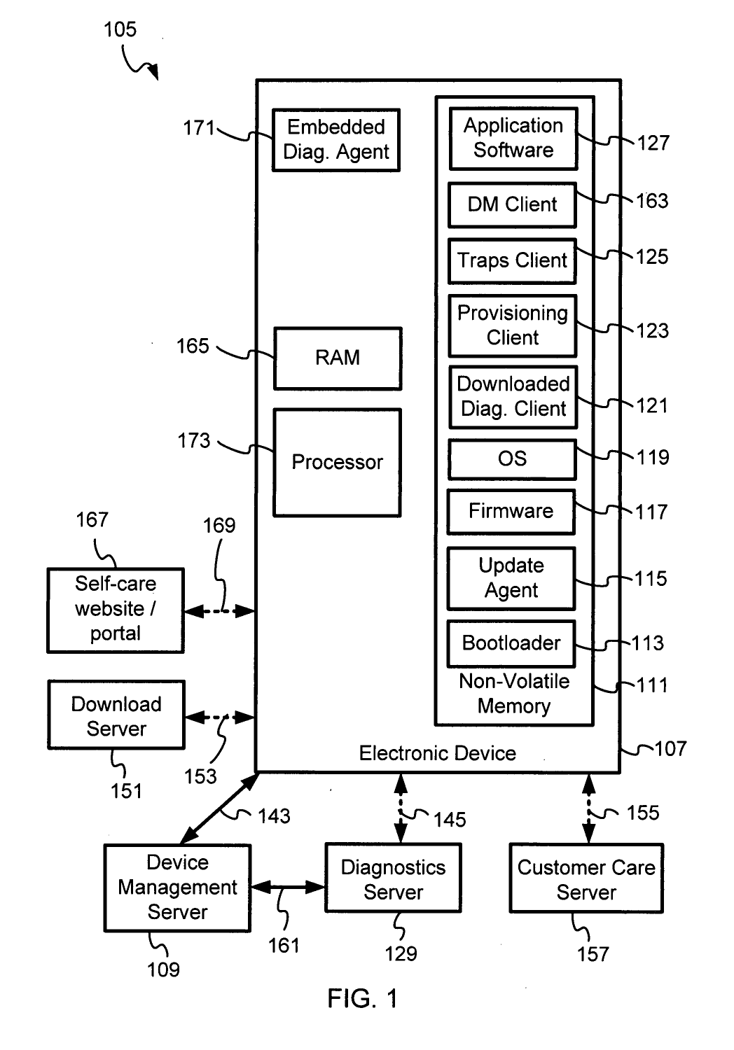

FIG. 1 is a perspective block diagram of an exemplary network 105 that supports remote diagnosis of an electronic device 107 such as, for example, a mobile handset or personal digital assistant, in accordance with a representative embodiment of the present invention. The electronic device 107 may, for example, comprise a cellular phone, a personal digital assistant (PDA), a pager, a handheld personal computer (PC), and/or the like. The electronic device 107 may support a number of features and/or applications that may at some time malfunction and need to be diagnosed. The electronic device 107 may itself be used to request customer care service via a customer care server 157 either directly, using a browser in the electronic device 107, or via a customer service representative (CSR). A CSR may, for example, provide service to the customer using the electronic device 107 by retrieving, as necessary, one or more diagnostic management objects (MOs) stored in memory of the electronic device 107. For reasons of clarity, the present application uses the terms “management object” and “device management object” interchangeably.

The network 105 supports customer care calls by a customer/subscriber/user of the electronic device 107 that is having problems with the device, and that may need help in diagnosing the problems and in finding an appropriate solution. Determining appropriate solutions may employ diagnostic information retrieved from the electronic device 107 by a server in the network 105, based upon a request by the user of the electronic device 107, or by a CSR.

A representative embodiment of the present invention may employ a device management (DM) technique in which diagnostics management objects (diagnostics MOs) are managed (e.g., created, edited, replaced, deleted, downloaded, updated) in a device management tree in memory of an electronic device such as electronic device 107, by a remote server in a carrier network such as the network 105 of FIG. 1. Such diagnostic management objects may be extensions to the set of management objects defined in a standards-based device management tree such as, for example, that supported by the SyncML Device Management (DM) protocol developed under the guidance of the Open Mobile Alliance (OMA). The diagnostic management objects of a representative embodiment of the present invention may be employed in detecting and resolving problems with specific features or applications of an electronic device. The network 105 may be capable of simultaneously supporting customer care calls from a number of customers/subscribers of electronic devices such as, for example, the electronic device 107 of FIG. 1, who experience problems and need help in diagnosing/correcting such problems. Using the diagnostics MOs of a representative embodiment of the present invention, the network 105 is able to provide an appropriate solution based on the diagnostics information retrieved from the electronic device 107.

As shown in the illustration of FIG. 1, the network 105 in a representative embodiment of the present invention may comprise the electronic device 107, a device management (DM) server 109, a customer care server 157, a diagnostics server 129, a self-care website/portal 167, and a download server 151. The electronic device 107 of FIG. 1 is able to communicate with the DM server 109, the download server 151, the diagnostics server 129, the customer care server 157 and the self-care website/portal 167 via communication paths 143, 153, 145, 155, 169, respectively. Although the communication paths 143, 153, 145, 155, 169 are illustrated as being separate paths between the electronic device 107 and their respective servers, this is only for purpose of illustration, and is not a specific limitation of the present invention. The communication paths 143, 153, 145, 155, 169 may be combined in one or more paths that may comprise wired or wireless communication paths such as, for example, a local area network, a public switched telephone network, a wireless personal, local or wide area network, and a cellular or paging network, to name only a few possibilities.

As illustrated in FIG. 1, an electronic device in accordance with a representative embodiment of the present invention may comprise a processor 173, random access memory (RAM) 165, an embedded diagnostic agent 171, and non-volatile memory 111. The non-volatile memory 111 may comprise, for example, NAND or NOR type flash memory or other suitable type of non-volatile memory. The non-volatile memory 111 may contain a number of code components of the electronic device 107 including, for example, application software 127, a device management (DM) client 163, a provisioning client 123, an operating system (OS) 119, firmware 117, an update agent 115, and a bootloader 113. The term “code” may be used herein to represent one or more of executable instructions, operand data, configuration parameters, and other information stored in memory of the electronic device 107.

In a representative embodiment of the present invention, an electronic device such as the electronic device 107 may employ an update package delivered by the download server 151 to update code components in memory of the electronic device 107. Such an update package may comprise update information including, for example, meta data describing an update and instructions executable by one or more update agents such as, for example, the update agent 115 of FIG. 1. The update agent(s) may process respective portion of the executable instructions of the update package to convert/transform respective portions of a first/current version of code in memory of the electronic device 107 to portions of a second/updated version of code. The electronic device 107 is also capable of receiving provisioning information from, for example, the customer care server 157, the diagnostic server 129, or a provisioning server (not shown) to fix configuration problems or reconfigure software and hardware.

In addition to those elements described above, the electronic device 107 may comprise a downloaded diagnostic client 121 that facilitates remote diagnosis, and a traps client 125 that facilitates the setting of traps and retrieving of collected information. The DM client 163 of the electronic device 107 may interacting with the DM server 109, with the diagnostic client 121 and with the traps client 125, to receive DM commands from the DM server 109 and implement them in the electronic device 107. The download server 151 may be employed to download firmware and software updates (e.g., update information in the form of, for example, update packages). The download server 151 may also be used to download a diagnostics client such as, for example, the downloaded diagnostic client 121 of FIG. 1, that may then be installed and activated in the electronic device 107.

A representative embodiment of the present invention may also comprise a diagnostic agent such as the embedded diagnostic agent 171 of FIG. 1, to support collecting different types of communication parameters, radio frequency configuration information, and voice and data services monitoring functionality, for example. The downloaded diagnostic client 121 may enable monitoring operating system activities, memory configurations, application configurations, software installation preferences, application software problems, and operating system problems, to name just a few items.

Representative embodiments of the present invention support a device management (DM) approach wherein diagnostics management objects (MOs) are used for each feature domain or application to help retrieve problem details, and to collected data and associated device capability information. Such diagnostics management objects may be extensions to a standards-based device management protocol such as, for example, the SyncML device management (DM) protocol developed under the guidance of the Open Mobile Alliance. Each application installed/updated in an electronic device such as, for example, the electronic device 107 of FIG. 1 may have an associated diagnostic MO that gets created/installed in a device management data structure such as a device management tree, stored in the memory of the electronic device. A remote server such as, for example, the customer care server 157 or the diagnostic server 129 of FIG. 1 may query or manipulate the diagnostics management object, via the DM server 109, to resolve problems and provide problem solutions. A diagnostic server such as the diagnostic server 129 of FIG. 1, for example, may communicate with the DM server 109 via an interface such as the interface 161. In some representative embodiments of the present invention, the interface 161 may comprise, for example, a web services interface. In a similar manner, the customer care server 157 may also interact with the DM server 109 via a web services interface (not shown).

In a representative embodiment of the present invention, when an application or service such as, for example, the application software 127 or associated service is installed on an electronic device (e.g., the electronic device 107), an alert/message may be sent to a remote server such as, for example, the DM server 109 or another server, via the DM server 109. This alert/message may provide details regarding the application and/or service installed by a user.

System operators/service providers of a network such as the network 105, for example, may enable/disable capabilities of an electronic device (e.g., electronic device 107) as needed, based upon diagnostic data collected from the electronic device 107. For example, even if an electronic device (e.g., the electronic device 107) supports all features of an application, if one feature is not properly configured the system operator/service provider may elect to disable that feature in the device (e.g., either temporarily or permanently), until the problem is diagnosed and fixed.

In a representative embodiment of the present invention, a device management object (MO) may be used to provide remote access to diagnostic functions that are able to be remotely invoked. One or more device management objects (MOs) may be used as a means to expose the diagnostic functions for remote management. A device management (DM) server may invoke the diagnostic functions through the MOs, and MO-specific behavior determines results that may be returned in-session, or return using a Generic Alert, which may be sent using subsequent asynchronous delivery. Such a device management object may be define as an extension to the set of management objects defined in a standards-based device management protocol such as, for example, the SyncML DM protocol developed under the guidance of the Open Mobile Alliance (OMA). The means to access such a diagnostic function may comprise a management object node of a diagnostics management object. A diagnostics management object in accordance with a representative embodiment of the present invention may be created within a device management tree structure in the memory of the electronic device, and may enable remote monitoring and trapping of electronic device behavior, and the return of collected events and parameters from the electronic device. Such diagnostic functions may return results data in an encrypted form (e.g., for security reasons) or in plain-text form, as instructed by the system operator. In a representative embodiment of the present invention, control over the return of any results may be provided using a management object node of the diagnostics management object, thereby permitting encryption of returned results to be enabled and disabled, as desired.

In a representative embodiment of the present invention, a diagnostics MO may be part of a DM tree that is maintained by a DM client such as, for example, the DM client 163 in the electronic device 107 of FIG. 1. A diagnostics management object in accordance with a representative embodiment of the present invention may be queried from a remote device management server such as, for example, the DM server 109, using an extensible markup language (XML) “Get” command, for example. Monitoring and trapping functionality of a diagnostics function associated with a diagnostics MO may be activated by sending an XML “Exec” command to the associated node of the DM tree. When activated/invoked, a diagnostics function (e.g., one or more diagnostics functions, if and as desired) associated with a diagnostics MO may be invoked, and any results gathered (e.g., parameters, measurements, values, etc.) may be returned to the remote server (e.g., the DM server 109 or to other servers via the DM server 109) using an alert mechanism, for example. Such an alert may comprise a Generic Alert mechanism such as, for example, a generic alert using XML. The collected parameters, data, etc. to be returned by the electronic device (e.g., electronic device 107) may be encrypted using an OEM (original equipment manufacturer)-specific certificate, if desired, so that only an authorized recipient/consumer (e.g., an OEM server), may access them later.

A representative embodiment of the present invention may employ a traps client such as the traps client 125 of FIG. 1. A traps client may be employed (i.e., “set”) for applications software on the electronic device (e.g., applications software 127) that may fail or “crash”, misbehave in some fashion, or consume unauthorized resources (e.g., memory, communication bandwidth, etc.), for example. Traps may be “set”, for example, for the purpose of monitoring components of an operating system (e.g., OS 119), for detecting radio network events, to monitor device resource consumption, and to perform device response evaluations, to name only a few possible uses.

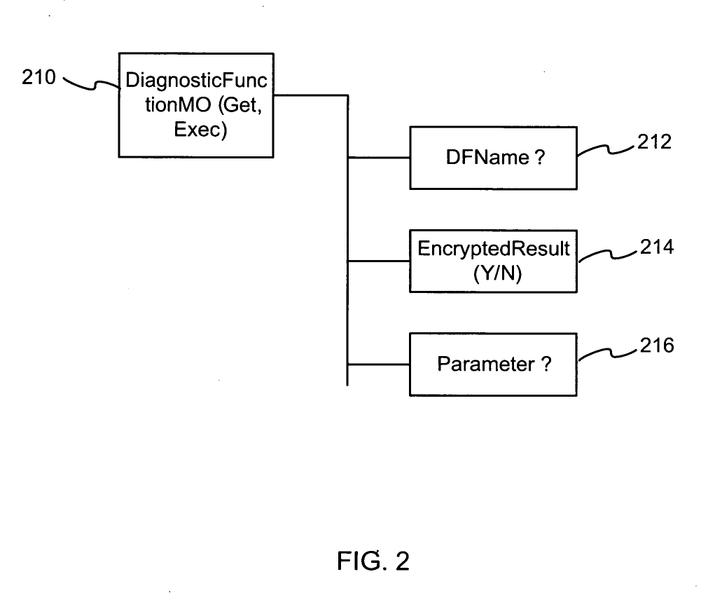

FIG. 2 shows elements of an exemplary simple diagnostic function management object (MO) (DiagnosticFunctionMO) 210, in accordance with a representative embodiment of the present invention. The DiagnosticFunctionMO 210 shown in FIG. 2 comprises a DFName node element 212 to indicate a name identifier for the diagnostic function, an EncryptedResult node element 214 that indicates whether results produce by the diagnostic function are to be returned in encrypted form, and a Parameter node element 216 that represents a parameter to be used in the invocation of the diagnostic function. The diagnostic function associated with the DiagnosticFunctionMO 210 may be invoked by a remote server using, for example, an XML “Exec” command. Results may be communicated at the end of the execution of the diagnostic function using, for example, an XML “Get” command, or asynchronously using a Generic Alert in XML format. Results to be returned may be encrypted or not (i.e., in plain-text), based on a preference setting stored in the EncryptedResult node element 214.

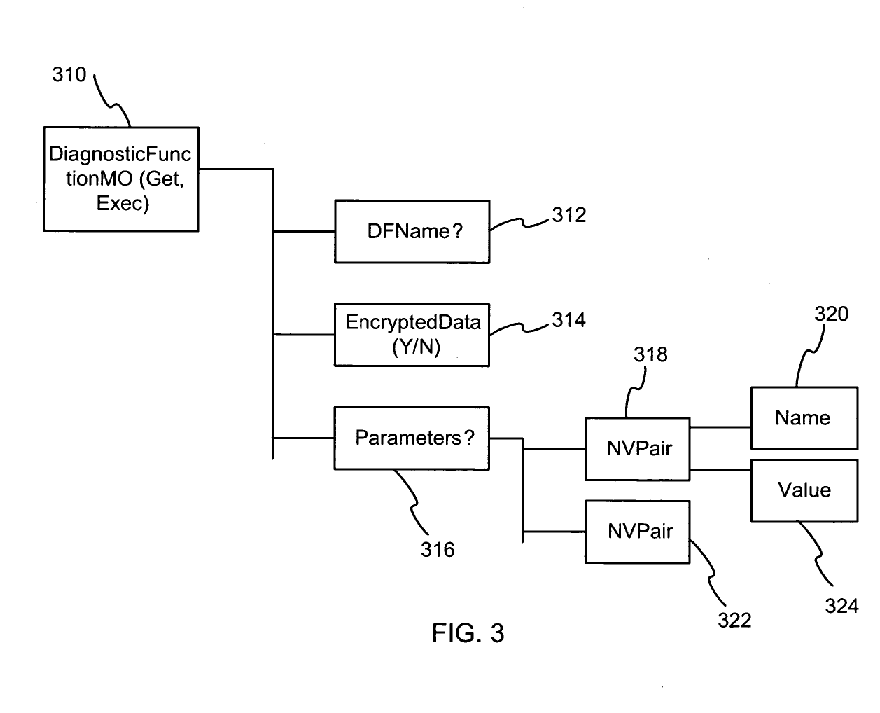

FIG. 3 shows elements of an exemplary diagnostic function MO (DiagnosticFunctionMO) 310 with name-value pair parameters, in accordance with a representative embodiment of the present invention. The DiagnosticFunctionMO 310 of FIG. 3 is similar to the DiagnosticFunction 210 in FIG. 2, and comprises a DFName node element 312 to indicate a name identifier for the diagnostic function, an EncryptedResult node element 314 that indicates whether results produce by the diagnostic function are to be returned in encrypted form, and a Parameter node element 316 that represents parameters to be used in the invocation of the diagnostic function. The DiagnosticFunctionMO 310, however, also comprises NVPair node element 318 having Name node element 320 and Value node element 324. A second NVPair node element 322 is shown without corresponding Name and Value node elements. A representative embodiment of the present invention permits multiple name-value pair parameters such as NVPair node elements 318, 322.

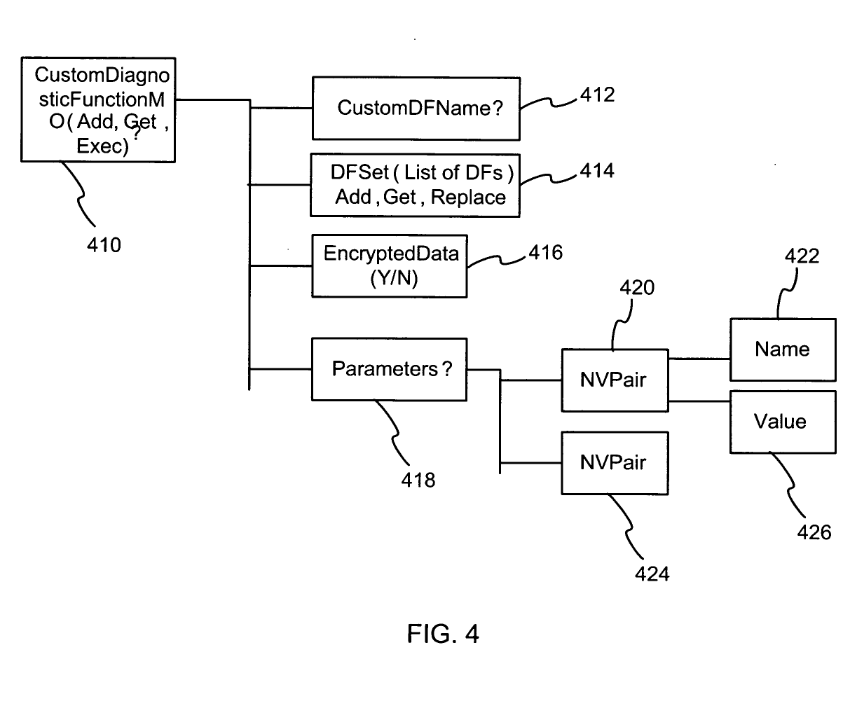

FIG. 4 illustrates the elements of an exemplary custom diagnostic function MO (CustomDiagnosticFunctionMO) 410, in accordance with a representative embodiment of the present invention. The CustomDiagnosticFunctionMO 410 of FIG. 4 is similar to the DiagnosticFunctionMO 310 in FIG. 3, and comprises a CustomDFName node element 412 to indicate a name identifier for the custom diagnostic function, and an EncryptedResult node element 416 that indicates whether results produce by the diagnostic function are to be returned in encrypted form. The CustomDiagnosticFunctionMO 410 includes a node element DFSet 414. A customized set of diagnostic functions may be enumerated in node element DFSet 414. Results to be returned may comprise data produced by each of the diagnostic functions in the set. In a representative embodiment of the present invention, some of the diagnostic functions in the set may be remote enabled and disabled.

The CustomDiagnosticFunctionMO 410 also includes a Parameter node element 418 that represents parameters to be used in the invocation of a set of diagnostic functions, similar to that shown in the DiagnosticFunctionMO 310 of FIG. 3, that comprises NVPair node element 420 having Name node element 422 and Value node element 426. A second NVPair node element 424 is also shown without corresponding Name and Value node elements.

Table 1 shows a list of exemplary device status management object settings, in accordance with a representative embodiment of the present invention.

TABLE 1

| | |
|---|---|
| DevStat [20] | Device status information |
| BatStr [21] | Battery strength in % |
| SigStr [22] | Signal strength in DB |
| RoamInd [23] | Roaming indicator |
| SysNet [24] | Current system/network settings |
| SID | Current SID |
| NID | Current NID |
| MemStat [25] | Free memory in bytes |
| ProvStat [26] | Provisioning status, 0, 1, or error |
| SubLokStat [27] | Subsidy lock status (1 if used) |
| MobIPCap [28] | Mobile IP capability parameters |
| PRLVer [29] | PRL ID |
| IS683 [30] | IS-683 “tunneling” |
| list | Placeholder, one node per entry |
| IS683Req | IS-683 request block |
| IS683Res | IS-683 response block |
| Objects [32] | Applications and other objects |
| list | Placeholder, one node per entry |
| Cert | Carrier/Enterprise Certified? |
| Name | Object/application name |
| Type | Object/application MIME type |
| Vnd | Object/application vendor |
| Ver | Object/application version |
| Time | Data/time installed |

A representative embodiment of the present invention may employ trap and/or diagnostic monitor management objects in the following manner. At a first point in time, a management authority such as, for example, a device management server such as the DM server 109 of FIG. 1 may create a trap/diagnostic monitor MO in a device management tree in memory of an electronic device such as, for example, the electronic device 107 of FIG. 1. At some later point in time, when the associated event occurs in the electronic device, the electronic device may inform the DM Server 109 of the occurrence of the event. This is similar in some ways to traditional simple network management protocol (SNMP) traps used in network management in which an “Alarm” is reported. In a representative embodiment of the present invention, a set of variable bindings may also be reported.

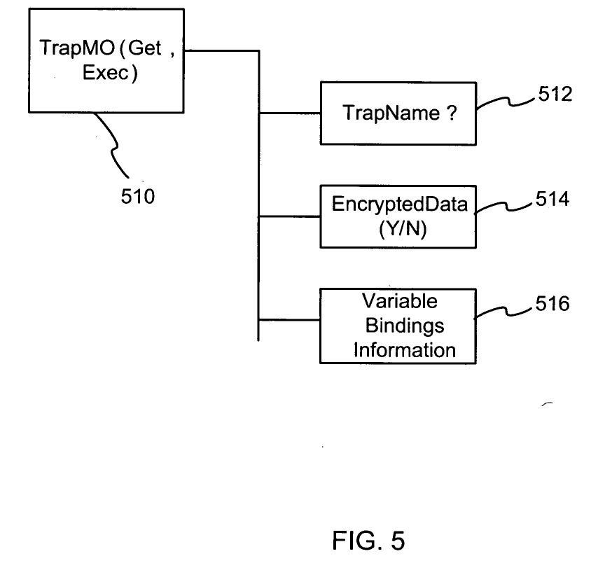

FIG. 5 illustrates the elements of an exemplary trap MO (TrapMO) 510, in accordance with a representative embodiment of the present invention. A trap MO in accordance with a representative embodiment of the present invention may collect data when an event occurs and subsequently report the collected data to a remote server. The TrapMO 510 shown in FIG. 5 comprises a TrapName node element 512 to indicate a name identifier for the trap, an EncryptedData node element 514 that indicates whether notification of the occurrence of the trap is to be returned in encrypted form, and a Variable Binding Information node element 516 that represents a set of variable bindings associated with the trap. The variable bindings represent context data assembled upon occurrence of the trap, which are to be reported to the remote server (e.g., DM server 109 or diagnostic server 129 of FIG. 1).

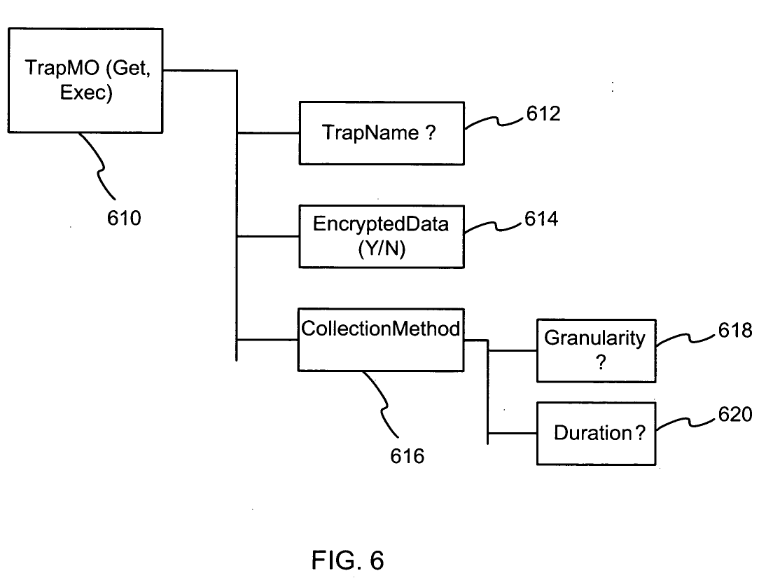

FIG. 6 illustrates the elements of another exemplary trap management object (TrapMO) 610, in accordance with a representative embodiment of the present invention. TrapMO 610 shown in FIG. 6 is similar to the TrapMO 510 shown in FIG. 5, and comprises a TrapName node element 612 to indicate a name identifier for the trap, and an EncryptedData node element 614 that indicates whether notification of the occurrence of the trap is to be returned in encrypted form. The example TrapMO 610 of FIG. 6, however, also comprises a CollectionMethod node element 616 having Granularity node element 618 and Duration node element 620. The Granularity node element 618 defines the interval between collection of data, and the Duration node element 620 defines the total time interval over which collection of data is to occur. In a representative embodiment of the present invention, the duration of data collection for a trap MO such as the TrapMO 610 may be explicitly defined, as in FIG. 6, or may be implicitly defined. In the case of an explicitly defined duration, data collection may be invoked immediately, and may continue for a specified duration (e.g., as relevant to the trap). In the case of an implicitly defined duration, data collection is invoked right away, and the associated collection method or function has an implicit duration and, therefore, no duration of data collection needs to be specified. As in the TrapMO 510, at the end of the collection interval, the collected data is reported to the remote server (e.g., DM server 109 or diagnostic server 129 of FIG. 1).

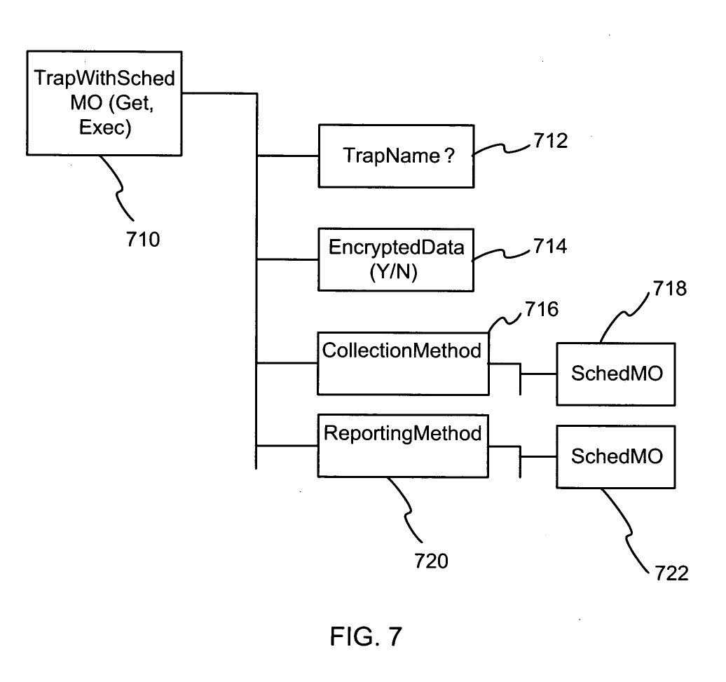

FIG. 7 illustrates the elements of an exemplary trap with schedule management object (TrapWithSchedMO) 710 with a schedule for collecting and reporting, in accordance with a representative embodiment of the present invention. TrapWithSchedMO 710 shown in FIG. 7 is similar in some ways to TrapMO 610 shown in FIG. 6, and comprises a TrapName node element 712 to indicate a name identifier for the trap, and an EncryptedData node element 714 that indicates whether notification of the occurrence of the trap is to be returned in encrypted form. The example TrapWithSchedMO 710 of FIG. 7 also comprises a CollectionMethod node element 716 having a SchedMO node element 718 and ReportingMethod node element 720 having a SchedMO node element 722. The SchedMO node elements 718, 722 represent scheduling management objects used, respectively, for scheduling the collection and reporting of data to a remote server, such as the DM server 109 of FIG. 1. DM scheduling objects such as, for example, SchedMO node elements 718, 722 may be used to schedule the invocation of a diagnostic function. In a representative embodiment of the present invention, a trap may be used to flag an event or incident. Data collection may then occur per the information in an associated scheduling MO, while reporting of collected data may then occur per an associated scheduling MO. As in the management objects TrapMO 510, 610, when reporting occurs, the collected data is transmitted to a remote server (e.g., DM server 109 or diagnostic server 129 of FIG. 1).

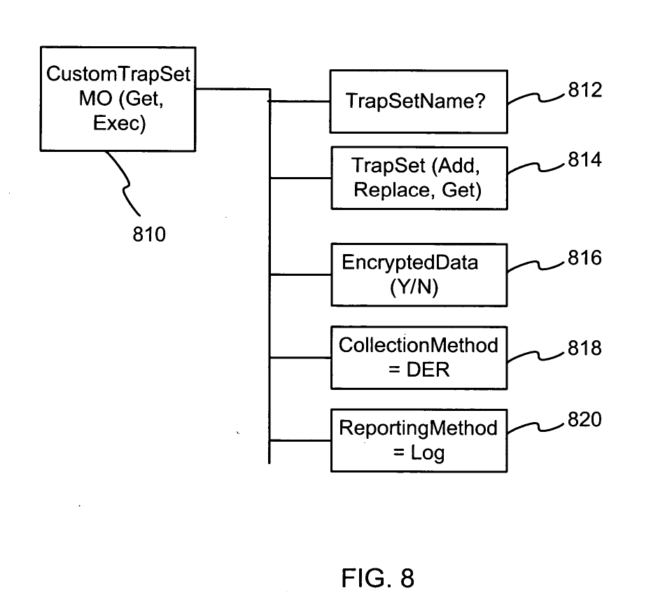

FIG. 8 illustrates the elements of an exemplary custom trap set management object (CustomTrapSetMO) 810 with a schedule for collecting and reporting, in accordance with a representative embodiment of the present invention. Device management object CustomTrapSetMO 810 shown in FIG. 8 comprises a TrapSetName node element 812 to indicate a name identifier for the custom trap set, and an EncryptedData node element 816 that indicates whether notification of the occurrence of the trap is to be returned in encrypted form. The CustomTrapSetMO 810 also includes a node element TrapSet 814, that may be used to enumerate a customized set of traps. Results to be returned to a remote server may comprise data related to any triggered traps in the set. In a representative embodiment of the present invention, some of the traps in the set may be disabled. The CustomTrapSetMO 810 of FIG. 8 also comprises a CollectionMethod node element 818 and ReportingMethod node element 820. In the example of FIG. 8, the CollectionMethod node element 818 indicates that collection is to use discrete event registration (DER), and ReportingMethod node element 820 indicates that a log of event data is to be returned to the remote server.

Table 2 shows details of a trap that may correspond to, for example, the CustomerTrapSetMO 810 of FIG. 8, in accordance with a representative embodiment of the present invention.

TABLE 2

| | |
|---|---|
| IncidentTrap | Incident (alerts & warnings) log |

[list of Incidents of Interest] Placeholder, one node per entry

Reporting Method - Log
Collection Method - DER

Data Collected:

| | |
|---|---|
| Time | Date/Time of log entry |
| Loc | IS-683 Latitude/Longitude OHP type |
| Type | Incident type code |
| NAI | Network access identifier |
| ProvStat | Provisioning status, 0, 1, or error |
| Msg | Binary event message block |

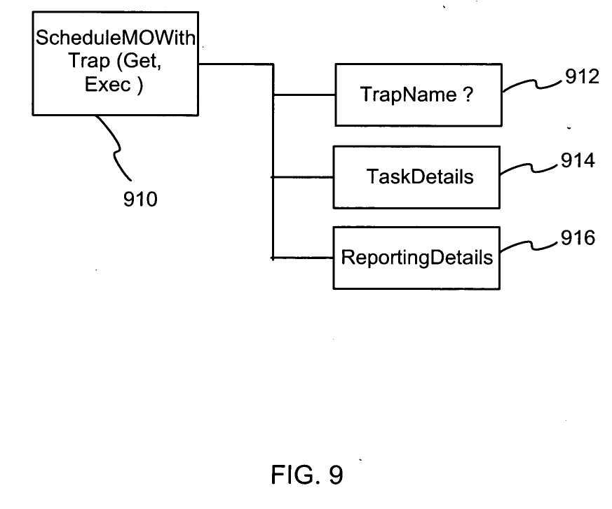

FIG. 9 illustrates the elements of an exemplary scheduling management object with trap (ScheduleMOWithTrap) 910, in accordance with a representative embodiment of the present invention. Device management object ScheduleMOWithTrap 910 shown in FIG. 9 comprises a TrapName node element 912 to indicate a name identifier for the trap, a TaskDetails node element 914 that provides scheduling and task information for the associated trap, and a node element ReportingDetails 916 that provides details related to the reporting to a remote server of data associated with the trap. To employ an instance of the scheduling management object with trap (i.e., ScheduleMOWithTrap), a scheduling object that specifies a task may be used in conjunction with a diagnostic management object. In accordance with a representative embodiment of the present invention, a DM server (e.g., DM server 109 of FIG. 1) may create a Trap MO and a Schedule MO in the electronic device of interest (e.g., electronic device 109 of FIG. 1). The Trap MO monitors the electronic device, and when the trap fires, the scheduled actions may be performed. The results may be reported immediately per a trap specified reporting method, or the results may be logged and the log communicated per a specified schedule.

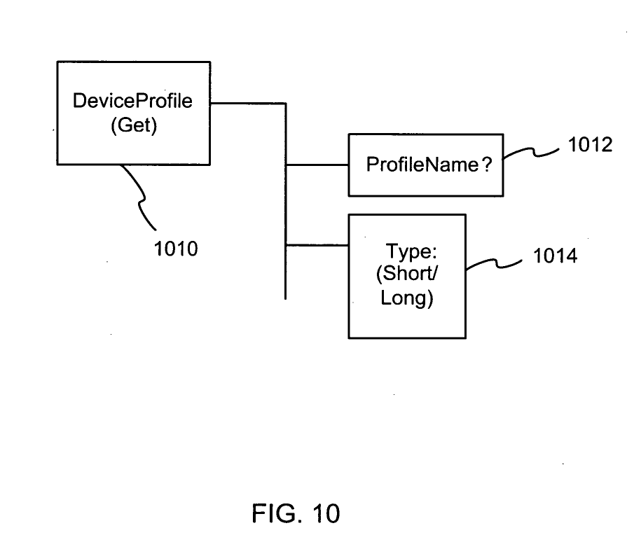

FIG. 10 illustrates elements of an exemplary device profile management object DeviceProfile MO 1010, in accordance with a representative embodiment of the present invention. The DeviceProfile MO 1010 comprises a ProfileName node element 1012, to indicate a name identifier for the device profile, and a Type node element 1014 that may be used to indicate whether a short or long device profile is to be returned. The DeviceProfile MO 1010 may be used by a remote server such as, the DM server 109 or customer care server 157 of FIG. 1, to retrieve a device profile for customer care or automated diagnosis. The retrieved device profile may comprise a collection of device management objects of the DM tree in the electronic device of interest (e.g., electronic devic 107 of FIG. 1). As in the example shown in FIG. 10, a default device profile may be returned. A device profile MO in accordance with a representative embodiment of the present invention such as, for example, the DeviceProfile MO 1010 of FIG. 10 has a number of advantages over prior approaches. For example, multiple device management objects (MOs) or subsets thereof may be efficiently retrieved, individual user and subscriber specific data may be accessed, and mostly static data may be retrieved using an XML “Get” command on the MO node.

Table 3 shows details of a device profile management object with subscriber and device information such as, for example, the DeviceProfile MO 1010 of FIG. 10, in accordance with a representative embodiment of the present invention.

TABLE 3

| | |
|---|---|
| DiagTree [1] | Diagnostic DeviceProfile object |
| UsrData [2] | User-identifiable data |
| Phone [3] | Phone Number |
| MDN [4] | Mobile Directory Number |
| NAM [5] | Number assignment module |
| ESN [6] | Electronic serial number |
| MSID [7] | Mobile station ID |
| MSID_TYPE | Mobile station ID type |
| MSID_LEN | Mobile station ID length |
| MSID_Data | Mobile station ID (includes ESN) |
| DevData [10] | Device-specific |
| DevType [11] | Device type |
| DevMod | Device model |
| DevVnd | Device vendor |
| DevVer | Device version |
| MstSubLok [12] | Master subsidy lock (SPL) flag |
| FWVer [13] | Firmware version |
| BrVnd [14] | Browser vendor |
| BrVer [15] | Browser version |

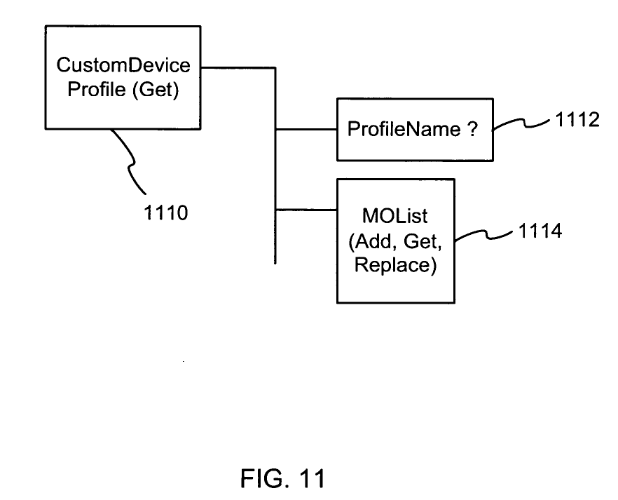

FIG. 11 illustrates the elements of an exemplary custom device profile management object CustomDeviceProfile MO 1110, in accordance with representative embodiment of the present invention. In the example illustrated in FIG. 11, CustomDeviceProfile MO 1110 comprises a node element ProfileName 1112 that may be used to provide a name identifier for the custom device profile, and a device management object list node element MOList 1114. A custom device profile in accordance with a representative embodiment of the present invention permits the definition of a list of parameters (e.g., device management objects (MOs)) like MOList 1114 that may be retrieved as part of the device profile. The list of parameters/MOs may be managed remotely (e.g., created, added, deleted, replaced, downloaded, initialized, etc.) using, for example, appropriate mechanisms of a device management protocol such as the SyncML DM device management protocol, for example. The CustomDeviceProfile MO 1114 may be employed to permit access to one device management object to be used to collect a group of statistical information on an electronic device. In addition, a representative embodiment of the present invention may, for example, support enabling and disabling the collection of the whole group of statistical information.

Table 4 is a list of exemplary statistical measures that may be collected using a device profile management object such as, or example, the CustomDeviceProfile MO 1110 of FIG. 11.

TABLE 4

| | |
|---|---|
| Stats [40] | Statistics and Averages |
| AvOrig [41] | Average origination time |
| OrigOK [42] | Origination success count |
| OrigRange [43] | Origination failures, out of range |
| OriglReject [44] | Origination failures, rejected |
| AveVCall [45] | Average voice call length |
| AveDCall [46] | Average data call length |
| ActTran [47] | Active/dormant transition count |
| MIPReg [48] | MIP (re-)registration count |
| PdownC [49] | Controlled power down count |
| PDownU [50] | Uncontrolled power down count |
| UpTime [51] | Total up time |
| ChTime [52] | Time between battery charges |
| CallDrop [53] | Call drop count |
| HOFail [54] | Failed handoff count |

In a representative embodiment of the present invention, various categories of data, device activity, and end user activity may, for example, be logged under the control of a remote server such as the DM server 109 or the diagnostic server 129 of FIG. 1, for example. In some representative embodiments, more than one log file may be created in the electronic device and transferred to the remote server.

Table 5 shows an exemplary list of types of logs and parameters that may be collected, in a representative embodiment of the present invention.

TABLE 5

| | |
|---|---|
| EvtLogs [60] | Error, Event, Incident logs |
| ErrLog [61] | Error history log |
| list | Placeholder, one node per entry |
| Time | Date/Time of log entry |
| Loc | IS-683 Latitude/Longitude OHP type |
| Code | Error code |
| Msg | Binary error message data block |
| IncLog [62] | Incident (alerts & warnings) log |
| list | Placeholder, one node per entry |
| Time | Date/Time of log entry |
| Loc | IS-683 Latitude/Longitude OHP type |
| Type | Incident type code |
| NAI | Network access identifier |
| ProvStat | Provisioning status, 0, 1, or error |
| Msg | Binary event message block |
| ConLog [63] | Connection log |
| list | Placeholder, one node per entry |
| Time | Date/Time of log entry |
| Loc | IS-683 Latitude/Longitude OHP type |
| Stat | Connection status, 1 for success |
| DLLog [64] | Download log |
| list | Placeholder, one node per entry |
| Time | Date/Time of log entry |
| Loc | IS-683 Latitude/Longitude OHP type |
| Stat | Download status, 1 for success |

Table 6 shows a list of exemplary state transition logs, in accordance with a representative embodiment of the present invention.

TABLE 6

| | |
|---|---|
| TransLogs [70] | State transitions FIFO logs |
| RoamLog [71] | Roaming transition log |
| list | Placeholder, one node per entry |
| Time | Date/Time of log entry |
| Loc | IS-683 Latitude/Longitude OHP type |
| SysIdx | System record index or |
| AcqIdx | Acquisition record index or |
| Active | Device active (1) or idle (0) |
| LowSigLog [72] | Low signal transition log |
| list | Placeholder, one node per entry |
| Time | Date/Time of log entry |
| Loc | IS-683 Latitude/Longitude OHP type |
| SigDB | Signal strength in DB |
| NoSig | No signal flag |
| SysParamLog [73] | System parameter transition log |
| list | Placeholder, one node per entry |
| Time | Date/Time of log entry |
| Loc | IS-683 Latitude/Longitude OHP type |
| Parms | IS-95B system parameter block |
| PilotLog [75] | Pilots seen log |
| list | Placeholder, one node per entry |
| Time | Date/Time of log entry |
| Loc | IS-683 Latitude/Longitude OHP type |
| SigDB | Signal strength in DB |
| ID | Pilot ID |
| SIDNIDLog [76] | SID/NID transition log |
| list | Placeholder, one node per entry |
| Time | Date/Time of log entry |
| Loc | IS-683 Latitude/Longitude OHP type |
| SID | System ID |
| NID | Network ID |
| L3Log [77] | Layer 3 message log |
| list | Placeholder, one node per entry |
| Time | Date/Time of log entry |
| Loc | IS-683 Latitude/Longitude OHP type |
| MsgID | Layers 3 message ID |
| Msg | Layer 3 message block |

A representative embodiment of the present invention may support the creation of device management objects (MOs) that facilitate configuration of diagnostics activities. For example, to configure the collection of quality of service (QoS) related parameters/measurements, it may be desirable to be able to refer to one or more specific QoS parameters or diagnostics (Diag) device management objects.

A representative embodiment of the present invention may support a number of QoS control objects (device management objects). For example, the following exemplary parameters may be included in a device management object used to specify what QoS information is to be collected:

| | |
|---|---|
| DiagSelect | Diagnostic data selector object |
| list | Placeholder, one item node per entry |
| ObjCode | Object to be reported |
| UserZoneID | UZ_ID in which to collect this data |
| Start | Date/time to start collecting |
| Stop | Date/time to stop collecting |
| Count | Repeat count |
| Interval | Repeat interval in seconds |

A representative embodiment of the present invention may employ the following exemplary parameters in a device management object used to establish a client initiated reporting schedule:

| | |
|---|---|
| DiagReq | Diagnostic data request object |
| list | Placeholder, one item node per entry |
| AnonUp | Anonymous upload? |
| ObjCode | Object to be reported |
| ItemReset | Reset object on each report? |
| Start | Date/time to report on this object |
| Interval | Repeat interval in seconds |

A representative embodiment of the present invention may employ the following exemplary parameters in a device management object used to identify to a remote server what information the client (i.e., the electronic device) is reporting:

| | |
|---|---|
| DiagRpt | Diagnostic data report object |
| list | Placeholder, one item node per entry |
| AnonUp | Anonymous upload? |
| ObjCode | Object being reported |

Although a system and method according to the present invention has been described in connection with the preferred embodiment, it is not intended to be limited to the specific form set forth herein, but on the contrary, it is intended to cover such alternative, modifications, and equivalents, as can be reasonably included within the scope of the invention as defined by this disclosure and appended diagrams.

What is claimed is:

1. A mobile electronic device comprising:
an interface for communicating with at least one remote server;
at least one processor operably coupled to the interface and to memory;
wherein the memory comprises executable code for causing the at least one processor to perform at least one diagnostic function on the electronic device; and
wherein data stored in the memory represents a device management tree comprising a device management object representing the at least one diagnostic function.

2. The device according to claim 1, wherein the at least one diagnostic function represented by the device management object is manageable by a server remote from the mobile electronic device.

3. The device according to claim 2, wherein management of the device management object comprises one or more of creation, deletion, installation, download and/or replacement of data associated with the device management object.

4. The device according to claim 2, wherein management of the device management object comprises one or more of creation, deletion, installation, download and/or replacement of the executable code for performing the at least one diagnostic function.

5. The device according to claim 1, wherein a format and/or content of results produced by the at least one diagnostic function are specific to the diagnostic function.

6. The device according to claim 1, wherein a format and/or content of results produced by the at least one diagnostic function are specified employing an extensible markup language (XML) data type definition (DTD) or an XML schema.

7. The device according to claim 1, wherein results are returned asynchronously employing a client initiated by the electronic device.

8. The device according to claim 1, wherein the at least one diagnostic function is instructed to return results in encrypted form.

9. The device according to claim 1, wherein returned results comprise data collected and encrypted by the at least one diagnostic function are retrievable employing a pull mechanism.

10. The device according to claim 9, wherein the pull mechanism employs a SyncML DM protocol GET command.

11. The device according to claim 1, wherein the at least one diagnostic function is identified by a unique identifier assigned by the manufacturer of the mobile electronic device.

12. The device according to claim 1, wherein the at least one diagnostic function is provided parameters by a device management (DM) server corresponding to the at least one diagnostic function.

13. The device according to claim 12, wherein parameters provided are explicitly identified by name, or implicitly identified by device management object node identification.

14. A mobile electronic device comprising:
an interface for communicating with at least one remote server;
at least one processor operably coupled to the interface and to memory;
wherein the memory comprises executable code for causing the at least one processor to monitor for events reportable by the mobile electronic device;
wherein data stored in the memory represents a device management tree comprising a trap device management object able to be armed by a device management (DM) server and/or based on a schedule provided by the mobile electronic device; and
wherein the trap device management object interacts with the monitoring code.

15. The device according to claim 14, wherein events are reported to a device management object in the device management tree.

16. The device according to claim 14, wherein events are reported to the at least one remote server.

17. The device according to claim 14, wherein the schedule is provided in a scheduling device management object.

18. The device according to claim 17, wherein the scheduling device management object comprises schedules for one or both of data collection and/or reporting.

19. A mobile electronic device comprising:
an interface for communicating with at least one remote server;
at least one processor operably coupled to the interface and to memory;
wherein the memory comprises executable code for causing the at least one processor to perform at least one diagnostic function on the electronic device;
wherein data stored in the memory represents a device management tree comprising a device management object representing the at least one diagnostic function, and a device management object representing scheduling; and
wherein the at least one diagnostic function is activated based upon schedule information provided by the scheduling device management object.

20. The device according to claim 19, wherein results produced by the at least one diagnostic function are logged, and wherein the logged results are communicated to the at least one remote server according to schedule information provided by the scheduling device management object.
